(19) United States
(12) Patent Application Publication
(10) Pub. No.: US 2013/0195119 A1
(43) Pub. Date: Aug. 1, 2013

(54) FEEDBACK CHANNEL FOR WIRELESS DISPLAY DEVICES

(71) Applicants: Xiaolong Huang, San Diego, CA (US); Vijayalakshmi R. Raveendran, San Diego, CA (US); PhaniKumar K. Bhamidipati, San Diego, CA (US); Fawad Shaukat, San Diego, CA (US); Xiaodong Wang, San Diego, CA (US); Jeff S. Froelicher, San Diego, CA (US)

(72) Inventors: Xiaolong Huang, San Diego, CA (US); Vijayalakshmi R. Raveendran, San Diego, CA (US); PhaniKumar K. Bhamidipati, San Diego, CA (US); Fawad Shaukat, San Diego, CA (US); Xiaodong Wang, San Diego, CA (US); Jeff S. Froelicher, San Diego, CA (US)

(73) Assignee: QUALCOMM Incorporated, San Diego, CA (US)

(21) Appl. No.: 13/563,984

(22) Filed: Aug. 1, 2012

Related U.S. Application Data
(60) Provisional application No. 61/547,397, filed on Oct. 14, 2011.
(60) Provisional application No. 61/604,674, filed on Feb. 29, 2012.

(51) Int. Cl. H04L 12/24

(52) U.S. Cl. CPC H04L 41/0896
USPC 370/468

(57) ABSTRACT

A sink device in a Wireless Display (WD) system may send performance information feedback to a source device to adjust media data processing at the source device. The performance information feedback may include performance indicators of the WD system that are capable of being measured or calculated at the sink device based on received media data or request to adjust the transmission of media data. For example, the performance information feedback may include one or more of round trip delay, delay jitter, packet loss ratio, error distribution, and received signal strength indication (RSSI). The feedback channel may be piggybacked on a reverse channel architecture referred to as the User Input Back Channel (UIBC) implemented between the source device and the sink device.

This application claims the benefit of U.S. Provisional Application No. 61/547,397, filed Oct. 14, 2011 and U.S. Provisional Application No. 61/604,674, filed Feb. 29, 2012, the entire contents of which is incorporated herein by reference.

### TECHNICAL FIELD

The disclosure relates to transport and playback of media data and, more particularly, control over the transport and playback of media data.

### BACKGROUND

Wireless display (WD) systems include a source device and one or more sink devices. A source device may be a device that is capable of transmitting media content within a wireless local area network. A sink device may be a device that is capable of receiving and rendering media content. The source device and the sink devices may be either mobile devices or wired devices. As mobile devices, for example, the source device and the sink devices may comprise mobile telephones, portable computers with wireless communication cards, personal digital assistants (PDAs), portable media players, digital image capturing devices, such as a camera or camcorder, or other flash memory devices with wireless communication capabilities, including so-called “smart” phones and “smart” pads or tablets, or other types of wireless communication devices. As wired devices, for example, the source device and the sink devices may comprise televisions, desktop computers, monitors, projectors, printers, audio amplifiers, set top boxes, gaming consoles, routers, and digital video disc (DVD) players, and media servers.

A source device may send media data, such as audio video (AV) data, to one or more of the sink devices participating in a particular media share session. The media data may be played back at both a local display of the source device and at each of the displays of the sink devices. More specifically, each of the participating sink devices renders the received media data for presentation on its screen and audio equipment. In some cases, a user of a sink device may apply user inputs to the sink device, such as touch inputs and remote control inputs.

### SUMMARY

In general, this disclosure relates to techniques that enable a sink device in a Wireless Display (WD) system to send performance information feedback to the source device in order to adjust media data, e.g., audio video (AV) data, processing at the source device. A source and a sink device may implement WD communication techniques that are compliant with standards such as, WirelessHD, Wireless Home Digital Interface (WHDI), WiGig, Wireless USB and the Wi-Fi Display (WFD) standard currently under development. Additional information about the WFD standard may be found in Wi-Fi Alliance, “Wi-Fi Display Specification draft version 1.31,” Wi-Fi Alliance Technical Committee, Display Task Group, which is hereby incorporated by reference in its entirety. A WD system may occasionally experience media performance degradation due to packet loss or channel congestion between a source device and a sink device. It can be advantageous for the source device to be able to adjust its media data processing, e.g., coding and/or packet transmission operation, based on the performance degradation experienced at the sink device. The current WFD standard, however, does not include a mechanism by which the source device can receive performance information from the sink device.

The techniques of this disclosure may include establishing a feedback channel between a source device and a sink device in a WD system to allow the sink device to send performance information feedback to the source device. The performance information feedback may include performance indicators of the WD system and the media data communication channel that are capable of being measured or calculated at the sink device based on received media data. For example, the performance information feedback may include one or more of round trip delay, delay jitter, packet loss ratio, error distribution, packet error ratio, and received signal strength indication (RSSI). In some examples, a source device may make adjustments to the transmission of media data based on the performance information. In other examples, the sink device may provide performance information with explicit adjustments of the transmission of media data to be performed by the source device. For example, a performance information message may include a message to increase or decrease a bit rate, or transmit an instantaneous decoder refresh (IDR) frame. The feedback channel may be piggybacked on a reverse channel architecture referred to as the User Input Back Channel (UIBC) implemented to communicate user input received at the sink device to the source device.

In one example, a method of transmitting media data comprises transmitting media data to a sink device, wherein media data is transported according to a first transport protocol, receiving a message from the sink device, wherein the message is transported according to a second transport protocol, determining based at least in part on a data packet header whether the message includes one of: user input information or performance information based on a data packet header, and adjusting the transmission of media data based on the message.

In another example, a method of receiving media data comprises: receiving media data from a source device, wherein media data is transported according to a first transport protocol, transmitting a message to the source device, wherein the message is transported according to a second transport protocol, and indicating based at least in part on a data packet header whether the message includes one of: user input information or performance information.

In another example, a source device comprises means for transmitting media data to a sink device, wherein media data is transported according to a first transport protocol, means for receiving a message from the sink device, wherein the message is transported according to a second transport protocol, means for determining based at least in part on a data packet header whether the message includes one of: user input information or performance information and means for adjusting the transmission of media data based on the message.

In another example, a sink device comprises means for receiving media data from a source device, wherein media data is transported according to a first transport protocol, means for transmitting a message to the source device, wherein the message is transported according to a second transport protocol and means for indicating based at least in part on a data packet header whether the message includes one of: user input information or performance information.

In another example, a source device comprises a memory that stores media data, and a processor configured execute instructs to cause the source device to transmit media data to a sink device, wherein media data is transported according to a first transport protocol, process a message received from the sink device, wherein the message is transported according to a second transport protocol, determine based at least in part on a data packet header whether the message includes one of: user input information or performance information, and adjust the transmission of media data based on the message.

In another example, a sink device comprises a memory that stores media data; and a processor configured to execute instructs to cause the sink device to transmit to process media data received from a source device, wherein media data is transported according to a first transport protocol, transmit a message to the source device, wherein the message is transported according to a second transport protocol, and indicate based at least in part on a data packet header whether the message includes one of: user input information or performance information.

In another example, a computer-readable medium comprises instructions stored thereon that when executed in a source device cause a processor to transmit media data to a sink device, wherein media data is transported according to a first transport protocol, process a message received from the sink device, wherein the message is transported according to a second transport protocol, determine based on at least in part on a data packet header whether the message includes one of: user input information or performance information and adjust the transmission of media data based on the message.

In one example, a computer-readable medium comprises instructions stored thereon that when executed in a sink device cause a processor to process media data received from a source device, wherein media data is transported according to a first transport protocol, transmit a message to the source device, wherein the message is transported according to a second transport protocol, and indicate based at least in part on a data packet header whether the message includes one of: user input information or performance information.

The details of one or more examples of the disclosure are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating a wireless communication system including a source device and a sink device.

FIG. 2 is a conceptual diagram illustrating an example of a communications reference model.

FIG. 3 is a conceptual diagram illustrating a feedback packet used to signal performance information from the sink device as feedback to the source device.

FIG. 4 is a flowchart illustrating an exemplary operation of adapting the bit rate of media data based on performance information feedback from the sink device to the source device.

FIG. 5 is a conceptual diagram illustrating an exemplary message format for user input or feedback messages included in payload data of the feedback packet from FIG. 3 in several different scenarios.

FIG. 6 is a block diagram illustrating an example of a source device that implements techniques for adjusting the transmission of media data based on feedback information.

FIG. 7 is a block diagram illustrating an example of a sink device that implements techniques for providing feedback information.

FIG. 8 is a flowchart illustrating a technique for adjusting the transmission of media data based on feedback information.

FIG. 9 is a flowchart illustrating a technique for providing feedback information.

### DETAILED DESCRIPTION

In current WD systems, legacy feedback messaging is used to provide feedback from a sink device to a source device. The legacy feedback messaging proceeds as follows: the sink device requests a sequence parameter set (SPS) or picture parameter set (PPS); the source device responds with the SPS or PPS; the sink device requests to start streaming; and the sink device sends a user initiated human interface device command (HIDC) user input as the signal is generated. The sink device also calculates the Packet Error Rate (PER) for the communication channel as a value that keeps increasing in time. Current WD systems do not feedback the PER value to the source device.

According to the techniques of this disclosure, a feedback channel is established between sink device and source device to allow a sink device to send performance information feedback to source device. The feedback channel may send the performance information for both the communication channel and sink device back to source device in regular intervals. For example, according to the techniques, sink device may calculate the PER for either an audio or video channel in a sync window interval instead of over an increasing value in time. The sync window may be defined to be 1 second. A sink device, therefore, may compute the PER for every second and generates a feedback message to be sent to a source device. The techniques of this disclosure may include an error management process implemented at sink device to define and send back appropriate messages to source device in a format agreed upon by both source device and sink device. The error management system and the message format are explained in more detail below.

Upon receiving the performance information feedback, a source device may adjust how it processes subsequent media data sent to sink device. Based on the performance information feedback from sink device, source device may adjust its media data encoding operation and/or its packet transmission operation. For example, source device may encode subsequent media data at a lower quality to avoid similar performance degradation. In another example, source device may identify a specific packet that was lost and decide to retransmit the packet.

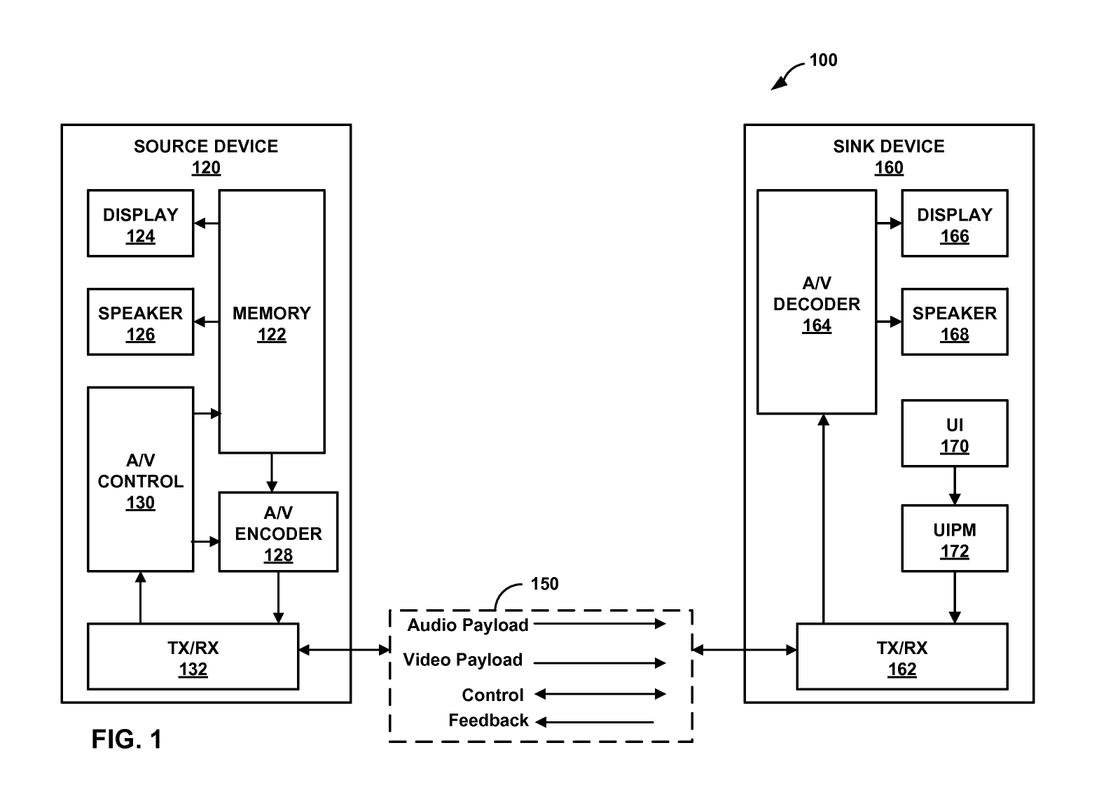

FIG. 1 is a block diagram illustrating an example of a Wireless Display (WD) system 100 including a source device 120 and a sink device 160 capable of supporting the adjustment of transmission of media data based on a performance information message. As shown in FIG. 1, WD system 100 includes source device 120 that communicates with sink device 160 via communication channel 150.

Source device 120 may include a memory 122, display 124, speaker 126, audio and/or video (AN) encoder 128, audio and/or video (AN) control module 130, and transmitter/receiver (TX/RX) unit 132. Sink device 160 may include transmitter/receiver unit 162, audio and/or video (AN) decoder 164, display 166, speaker 168, user input (UI) device 170, and user input processing module (UIPM) 172. The illustrated components constitute merely one example configuration for WD system 100. Other configurations may include fewer components than those illustrated or may include additional components than those illustrated.

In the example of FIG. 1, source device 120 can display the video portion of A/V data on display 124 and can output the audio portion of A/V data using speaker 126. A/V data may be stored locally on memory 122, accessed from an external storage medium such as a file server, hard drive, external memory, Blu-ray disc, DVD, or other physical storage medium, or may be streamed to source device 120 via a network connection such as the internet. In some instances A/V data may be captured in real-time via a camera and microphone of source device 120. A/V data may include multimedia content such as movies, television shows, or music, but may also include real-time content generated by source device 120. Such real-time content may for example be produced by applications running on source device 120, or video data captured, e.g., as part of a video telephony session. Such real-time content may in some instances include a video frame of user input options available for a user to select. In some instances, A/V data may include video frames that are a combination of different types of content, such as a video frame of a movie or TV program that has user input options overlaid on the frame of video.

In addition to rendering A/V data locally via display 124 and speaker 126, A/V encoder 128 of source device 120 can encode A/V data and transmitter/receiver unit 132 can transmit the encoded data over communication channel 150 to sink device 160. Transmitter/receiver unit 162 of sink device 160 receives the encoded data, and A/V decoder 164 may decode the encoded data and output the decoded data for presentation on display 166 and speaker 168. In this manner, the audio and video data being rendered by display 124 and speaker 126 can be simultaneously rendered by display 166 and speaker 168. The audio data and video data may be arranged in frames, and the audio frames may be time-synchronized with the video frames when rendered.

A/V encoder 128 and A/V decoder 164 may implement any number of audio and video compression standards, such as the ITU-T H.264 standard, alternatively referred to as MPEG-4, Part 10, Advanced Video Coding (AVC), or the newly emerging high efficiency video coding (HEVC) standard. Many other types of proprietary or standardized compression techniques may also be used. Generally speaking, A/V decoder 164 is configured to perform the reciprocal coding operations of A/V encoder 128. Although not shown in FIG. 1, in some aspects, A/V encoder 128 and A/V decoder 164 may each be integrated with an audio encoder and decoder, and may include appropriate MUX-DEMUX units, or other hardware and software, to handle encoding of both audio and video in a common data stream or separate data streams.

As will be described in more detail below, A/V encoder 128 may also perform other encoding functions in addition to implementing a video compression standard as described above. For example, A/V encoder 128 may add various types of metadata to A/V data prior to A/V data being transmitted to sink device 160. In some instances, A/V data may be stored on or received at source device 120 in an encoded form and thus not require further compression by A/V encoder 128.

Although, FIG. 1 shows communication channel 150 carrying audio payload data and video payload data separately, it is to be understood that in some instances video payload data and audio payload data may be part of a common data stream. If applicable, MUX-DEMUX units may conform to the ITU H.223 multiplexer protocol, or other protocols such as the user datagram protocol (UDP). A/V encoder 128 and A/V decoder 164 each may be implemented as one or more microprocessors, digital signal processors (DSPs), application specific integrated circuits (ASICs), field programmable gate arrays (FPGAs), discrete logic, software, hardware, firmware or any combinations thereof. Each of A/V encoder 128 and A/V decoder 164 may be included in one or more encoders or decoders, either of which may be integrated as part of a combined encoder/decoder (CODEC). Thus, each of source device 120 and sink device 160 may comprise specialized machines configured to execute one or more of the techniques of this disclosure.

Display 124 and display 168 may comprise any of a variety of video output devices such as a cathode ray tube (CRT), a liquid crystal display (LCD), a plasma display, a light emitting diode (LED) display, an organic light emitting diode (OLED) display, or another type of display device. In these or other examples, display 124 and 168 may each be emissive displays or transmissive displays. Display 124 and display 166 may also be touch displays such that they are simultaneously both input devices and display devices. Such touch displays may be capacitive, resistive, or other type of touch panel that allows a user to provide user input to the respective device.

Speaker 126 and speaker 168 may comprise any of a variety of audio output devices such as headphones, a single-speaker system, a multi-speaker system, or a surround sound system. Additionally, although display 124 and speaker 126 are shown as part of source device 120 and display 166 and speaker 168 are shown as part of sink device 160, source device 120 and sink device 160 may in fact be a system of devices. As one example, display 166 may be a television, speaker 168 may be a surround sound system, and A/V decoder 164 may be part of an external box connected, either wired or wirelessly, to display 166 and speaker 168. In other instances, sink device 160 may be a single device, such as a tablet computer or smartphone. In still other cases, source device 120 and sink device 160 are similar devices, e.g., both being smartphones, tablet computers, or the like. In this case, one device may operate as the source and the other may operate as the sink. These roles may be reversed in subsequent communication sessions. In still other cases, the source device 120 may comprise a mobile device, such as a smartphone, laptop or tablet computer, and the sink device 160 may comprise a more stationary device (e.g., with an AC power cord), in which case the source device 120 may deliver audio and video data for presentation to a one or more viewers via the sink device 160.

Transmitter/receiver unit 132 and transmitter/receiver unit 162 may each include various mixers, filters, amplifiers and other components designed for signal modulation, as well as one or more antennas and other components designed for transmitting and receiving data. Communication channel 150 generally represents any suitable communication medium, or collection of different communication media, for transmitting audio/video data, control data and feedback between the source device 120 and the sink device 160. Communication channel 150 is usually a relatively short-range communication channel, and may implement a physical channel structure similar to Wi-Fi, Bluetooth, or the like, such as implementing defined 2.4, GHz, 3.6 GHz, 5 GHz, 60 GHz or Ultrawideband (UWB) frequency band structures. However, communication channel 150 is not necessarily limited in this respect, and may comprise any wireless or wired communication medium, such as a radio frequency (RF) spectrum or one or more physical transmission lines, or any combination of wireless and wired media. In other examples, communication channel 150 may even form part of a packet-based network, such as a wired or wireless local area network, a wide-area network, or a global network such as the Internet. Additionally, communication channel 150 may be used by source device 120 and sink device 160 to create a peer-to-peer link.

Source device 120 and sink device 160 may establish a communication session according to a capability negotiation using, for example, Real-Time Streaming Protocol (RTSP) control messages. In one example, a request to establish a communication session may be sent by the source device 120 to the sink device 160. Once the media share session is established, source device 120 transmits media data, e.g., audio video (AV) data, to the participating sink device 160 using the Real-time Transport protocol (RTP). Sink device 160 renders the received media data on its display and audio equipment (not shown in FIG. 1).

Source device 120 and sink device 160 may then communicate over communication channel 150 using a communications protocol such as a standard from the IEEE 802.11 family of standards. In one example communication channel 150 may be a network communication channel. In this example, a communication service provider may centrally operate and administer one or more the network using a base station as a network hub. Source device 120 and sink device 160 may, for example, communicate according to the Wi-Fi Direct or Wi-Fi Display (WFD) standards, such that source device 120 and sink device 160 communicate directly with one another without the use of an intermediary such as wireless access points or so called hotspots. Source device 120 and sink device 160 may also establish a tunneled direct link setup (TDLS) to avoid or reduce network congestion. WFD and TDLS are intended to setup relatively short-distance communication sessions. Relatively short distance in this context may refer to, for example, less than approximately 70 meters, although in a noisy or obstructed environment the distance between devices may be even shorter, such as less than approximately 35 meters, or less than approximately 20 meters.

The techniques of this disclosure may at times be described with respect to WFD, but it is contemplated that aspects of these techniques may also be compatible with other communication protocols. By way of example and not limitation, the wireless communication between source device 120 and sink device may utilize orthogonal frequency division multiplexing (OFDM) techniques. A wide variety of other wireless communication techniques may also be used, including but not limited to time division multi access (TDMA), frequency division multi access (FDMA), code division multi access (CDMA), or any combination of OFDM, FDMA, TDMA and/or CDMA.

In addition to decoding and rendering data received from source device 120, sink device 160 can also receive user inputs from user input device 170. User input device 170 may, for example, be a keyboard, mouse, trackball or track pad, touch screen, voice command recognition module, or any other such user input device. UIPM 172 formats user input commands received by user input device 170 into a data packet structure that source device 120 is capable of processing. Such data packets are transmitted by transmitter/receiver 162 to source device 120 over communication channel 150. Transmitter/receiver unit 132 receives the data packets, and A/V control module 130 parses the data packets to interpret the user input command that was received by user input device 170. Based on the command received in the data packet, A/V control module 130 may change the content being encoded and transmitted. In this manner, a user of sink device 160 can control the audio payload data and video payload data being transmitted by source device 120 remotely and without directly interacting with source device 120.

Additionally, users of sink device 160 may be able to launch and control applications on source device 120. For example, a user of sink device 160 may able to launch a photo editing application stored on source device 120 and use the application to edit a photo that is stored locally on source device 120. Sink device 160 may present a user with a user experience that looks and feels like the photo is being edited locally on sink device 160 while in fact the photo is being edited on source device 120. Using such a configuration, a user may be able to leverage the capabilities of one device for use with several devices. For example, source device 120 may comprise a smartphone with a large amount of memory and high-end processing capabilities. When watching a movie, however, the user may wish to watch the movie on a device with a bigger display screen, in which case sink device 160 may be a tablet computer or even larger display device or television. When wanting to send or respond to email, the user may wish to use a device with a physical keyboard, in which case sink device 160 may be a laptop. In both instances, the bulk of the processing may still be performed by source device 120 even though the user is interacting with sink device 160. The source device 120 and the sink device 160 may facilitate two way interactions by transmitting control data, such as, data used to negotiate and/or identify the capabilities of the devices in any given session over communications channel 150.

In some configurations, A/V control module 130 may comprise an operating system process being executed by the operating system of source device 120. In other configurations, however, A/V control module 130 may comprise a software process of an application running on source device 120. In such a configuration, the user input command may be interpreted by the software process, such that a user of sink device 160 is interacting directly with the application running on source device 120, as opposed to the operating system running on source device 120. By interacting directly with an application as opposed to an operating system, a user of sink device 160 may have access to a library of commands that are not native to the operating system of source device 120. Additionally, interacting directly with an application may enable commands to be more easily transmitted and processed by devices running on different platforms.

User inputs applied at sink device 160 may be sent back to source device 120 over communication channel 150. In one example, a reverse channel architecture, also referred to as a user interface back channel (UIBC) may be implemented to enable sink device 160 to transmit the user inputs applied at sink device 160 to source device 120. The reverse channel architecture may include upper layer messages for transporting user inputs, and lower layer frames for negotiating user interface capabilities at sink device 160 and source device 120. The UIBC may reside over the Internet Protocol (IP) transport layer between sink device 160 and source device 120. In this manner, the UIBC may be above the transport layer in the Open System Interconnection (OSI) communication model. To promote reliable transmission and in sequence delivery of data packets containing user input data, UIBC may be configured to run on top of other packet-based communication protocols such as the transmission control protocol/internet protocol (TCP/IP) or the user datagram protocol (UDP). UDP and TCP may operate in parallel in the OSI layer architecture. TCP/IP may enable sink device 160 and source device 120 to implement retransmission techniques in the event of packet loss.

The UIBC may be designed to transport various types of user input data, including cross-platform user input data. For example, source device 120 may run the iOS® operating system, while sink device 160 runs another operating system such as Android® or Windows®. Regardless of platform, UIPM 172 may encapsulate received user input in a form understandable to A/V control module 130. A number of different types of user input formats may be supported by the UIBC so as to allow many different types of source and sink devices to exploit the protocol regardless of whether the source and sink devices operate on different platforms. Generic input formats that are defined and platform specific input formats may both be supported, thus providing flexibility in the manner in which user input can be communicated between source device 120 and sink device 160 by the UIBC.

WD system 100 may occasionally experience media performance degradation due to packet loss or channel congestion between source device 120 and sink device 160. For example, video transmission over lossy and error prone communication networks is prone to errors introduced during transmission. For some applications it may be required to stream the video in real-time. In these applications, errors may provide an unacceptable user experience. It is desirable to take appropriate measures to correct or reduce the errors early in a communication session, e.g., before the losses increase to an unacceptable or unmanageable level. There are several stages at which the error introduced during transmission may be corrected or reduced. The current WFD standard does not include a mechanism by which source device 120 can receive performance information from sink device 160. It would be advantageous for source device 120 to be able to adjust its media data processing, e.g., coding and/or packet transmission operation, based on the performance experienced at sink device 160 to reduce media performance degradation due to packet loss or channel congestion.

More particularly, sink device 160 may signal performance information to source device 120 using a feedback signal. A/V control module 130 in source device 120 may then parse the received signal to identify how to adjust A/V processing based on performance information. A/V control module 130 may modify operation of source device 120 and/or applications running on source device 120 to change the type of content being rendered and transmitted to sink device 160. According to the techniques of this disclosure, source device 120 and sink device 160 may support the adjustment of the transmission rate of media data based on a performance information message.

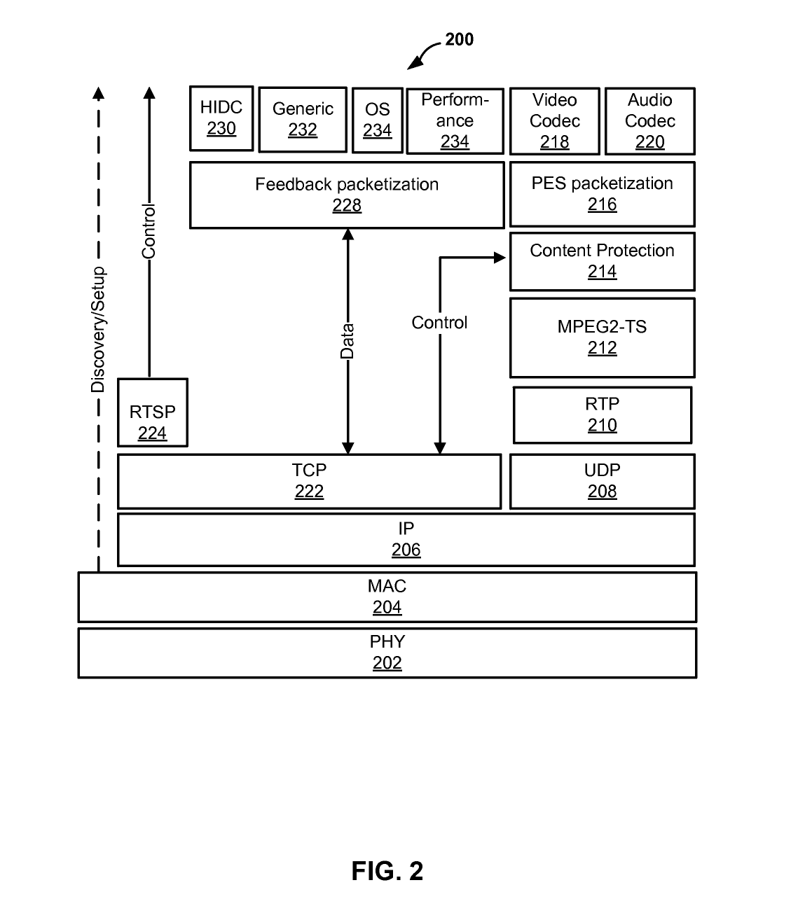

FIG. 2 is a block diagram illustrating an example of a data communication model or protocol stack for a WD system. Data communication model 200 illustrates the interactions between data and control protocols used for transmitting data between a source device and a sink device in an implemented WD system. In one example WD system 100 may use data communications model 200. Data communication model 200 includes physical (PHY) layer 202, media access control (MAC) layer (204), internet protocol (IP) 206, user datagram protocol (UDP) 208, real time protocol (RTP) 210, MPEG2 transport stream (MPEG2-TS) 212, content protection 214, packetized elementary stream (PES) packetization 216, video codec 218, audio codec 220, transport control protocol (TCP) 222, real time streaming protocol (RTSP) 224, feedback packetization 228, human interface device constants 230, generic user inputs 232, and performance analysis 234.

Physical layer 202 and MAC layer 204 may define physical signaling, addressing and channel access control used for communications in a WD system. Physical layer 202 and MAC layer 204 may define the frequency band structure used for communication, e.g., Federal Communications Commission bands defined at 2.4, GHz, 3.6 GHz, 5 GHz, 60 GHz or Ultrawideband (UWB) frequency band structures. Physical layer 202 and MAC 204 may also define data modulation techniques e.g. analog and digital amplitude modulation, frequency modulation, phase modulation techniques, and combinations thereof. Physical layer 202 and MAC 204 may also define multiplexing techniques, e.g. example, time division multi access (TDMA), frequency division multi access (FDMA), code division multi access (CDMA), or any combination of OFDM, FDMA, TDMA and/or CDMA. In one example, physical layer 202 and media access control layer 204 may be defined by a Wi-Fi (e.g., IEEE 802.11-2007 and 802.11n-2009x) standard, such as that provided by WFD. In other examples, physical layer 202 and media access control layer 204 may be defined by any of: WirelessHD, Wireless Home Digital Interface (WHDI), WiGig, and Wireless USB. Internet protocol (IP) 206, user datagram protocol (UDP) 208, real time protocol (RTP) 210, transport control protocol (TCP) 222, and real time streaming protocol (RTSP) 224 define packet structures and encapsulations used in a WD system and may be defined according to the standards maintained by the Internet Engineering Task Force (IETF).

RTSP 224 may be used by source device 120 and sink device 160 to negotiate capabilities, establish a session, and session maintenance and management. Source device 120 and sink device 160 may establish the feedback channel using an RTSP message transaction to negotiate a capability of source device 120 and sink device 160 to support the feedback channel and feedback input category on the UIBC. The use of RTSP negotiation to establish a feedback channel may be similar to using the RTSP negotiation process to establish a media share session and/or the UIBC.

For example, source device 120 may send a capability request message (e.g., RTSP GET_PARAMETER request message) to sink device 160 specifying a list of capabilities that are of interest to source device 120. In accordance with this disclosure, the capability request message may include the capability to support a feedback channel on the UIBC. Sink device 160 may respond with a capability response message (e.g., RTSP GET_PARAMETER response message) to source device 120 declaring its capability of supporting the feedback channel. As an example, the capability response message may indicate a “yes” if sink device 160 supports the feedback channel on the UIBC. Source device 120 may then send an acknowledgement request message (e.g., RTSP SET_PARAMETER request message) to sink device 160 indicating that the feedback channel will be used during the media share session. Sink device 160 may respond with an acknowledgment response message (e.g., RTSP SET_PARAMETER response message) to source device 120 acknowledging that the feedback channel will be used during the media share session.

Video codec 218 may define the video data coding techniques that may be used by a WD system. Video codec 218 may implement any number of video compression standards, such as ITU-T H.261, ISO/IEC MPEG-1 Visual, ITU-T H.262 or ISO/IEC MPEG-2 Visual, ITU-T H.263, ISO/IEC MPEG-4 Visual, ITU-T H.264 (also known as ISO/IEC MPEG-4 AVC), VP8 and High-Efficiency Video Coding (HEVC). It should be noted that in some instances WD system may either compressed or uncompressed video data.

Audio codec 220 may define the audio data coding techniques that may be used by a WD system. Audio data may be coded using multi-channel formats such those developed by Dolby and Digital Theater Systems. Audio data may be coded using a compressed or uncompressed format. Examples of compressed audio formats include MPEG-1, 2 Audio Layers II and III, AC-3, AAC. An example of an uncompressed audio format includes pulse-code modulation (PCM) audio format.

Packetized elementary stream (PES) packetization 216 and MPEG2 transport stream (MPEG2-TS) 212 may define how coded audio and video data is packetized and transmitted. Packetized elementary stream (PES) packetization 216 and MPEG-TS 212 may be defined according to MPEG-2 Part 1. In other examples, audio and video data may be packetized and transmitted according to other packetization and transport stream protocols. Content protection 214, may provide protection against unauthorized copying of audio or video data. In one example, content protection 214 may be defined according to High bandwidth Digital Content Protection 2.0 specification.

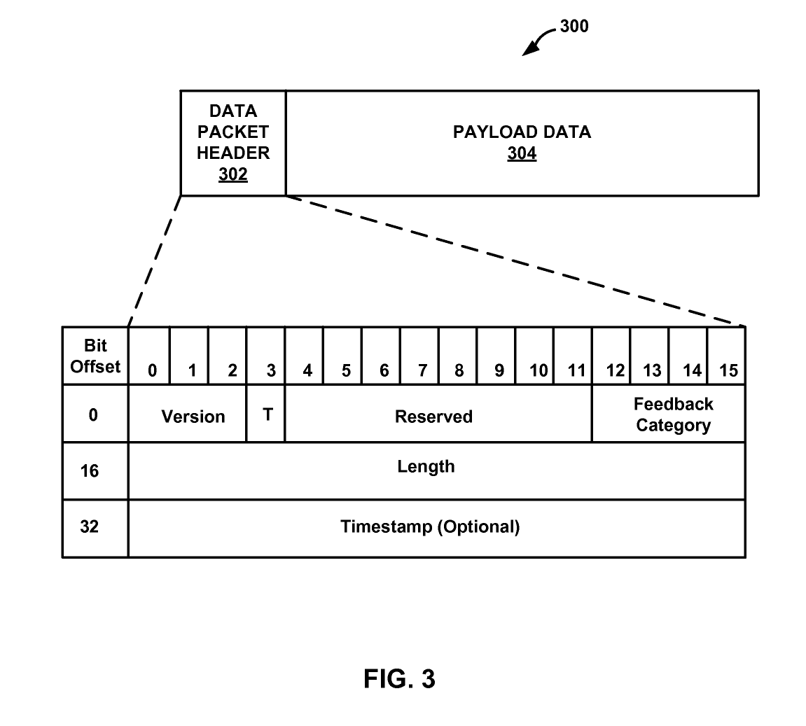

Feedback packetization 228 may define how user input and performance information is packetized. FIG. 3 is a conceptual diagram illustrating an example of a feedback packet 300 used to signal input or performance information from a sink device as to a source device. Feedback packet 300 includes a data packet header 302 and payload data 304. Feedback packet 300 may be transmitted from sink device 160 to source device 120 via the UIBC reverse channel architecture defined by WFD. In this manner, a feedback channel may be piggybacked on the UIBC reverse channel architecture implemented between sink device 160 and source device 120. To piggyback on the UIBC, a new input category called “feedback” may be utilized with the UIBC data packet header defined in WFD to indicate that the payload data of the UIBC packet includes performance information feedback. Based on the content of data packet header 302 of feedback packet 300, source device 120 may parses payload data 304 from a sink device 120. Based on payload data 304, source device 120 may alter the media data being transmitted from source device 120 to sink device 160.

An example of data packet header 302 is illustrated in FIG. 3. The numbers 0-15 identify bit locations within data packet header 302, and the numbers 0, 16 and 32 identify the bit offset between separate fields in data packet header 302. Data packet header 302 includes a version field, a timestamp flag (“T”), a reserved field, a feedback category field, a length field, and an optional timestamp field. In the example of FIG. 3, the version field is a 3-bit field that may indicate the version of a particular communications protocol being implemented by a sink device. The value in the version field may inform a source device how to parse the remainder of data packet header 302 as well as how to parse payload data 304. The timestamp flag is a 1-bit field that indicates whether or not the optional timestamp field is present in data packet header 302. The timestamp flag may, for example, include a “1” to indicate that the timestamp field is present, and may include a “0” to indicate that the timestamp field is not present. The reserved field is an 8-bit field reserved for use by future versions of a particular protocol identified in the version field.

In the example of FIG. 3, the feedback category field is a 4-bit field to identify an input category or performance information category for payload data 304 contained in feedback packet 300. The value of the feedback category field identifies to a source device the type of data included in payload data 304 and how payload data 304 is formatted. Based on this formatting, a source device determines how to parse payload data 304. As one example, the feedback category field may identify a generic input category to indicate that payload data 304 is formatted using generic information elements defined in a protocol being executed by both a source device and sink device. As another example, the feedback category field may identify a human interface device command (HIDC) input category to indicate that payload data 304 is formatted based on the type of user interface through which the input data is received at a sink device. As another example, the feedback category field may identify an operating system (OS) specific input category to indicate that payload data 304 is formatted based on the type OS used by either the source device or the sink device. According to the techniques of this disclosure, the feedback category field may also identify a feedback input category to indicate that payload data 304 is formatted based on a type of performance information determined at sink device. The feedback input category differentiates the payload data in the feedback packet from generic user input and HIDC user input. In the case of generic or HIDC user input, the effect of the user input on the subsequent media data sent to a sink device typically relates to how the media data is presented to the user at sink device, e.g., zoom and pan operations. In the case of feedback user input, the effect of the user input on the subsequent media data sent to sink device 160 typically relates to how source device 120 encodes and transmits the media data to sink device 160.

The timestamp field may comprise an optional 16-bit field that, when present, may contain a timestamp associated with media data generated by a source device and transmitted to a sink device. For example, source device 120 may have applied a timestamp to a media data packet prior to transmitting the media data packet to sink device 160. When present, the timestamp field in data packet header 302 may include the timestamp that identifies the latest media data packet received at sink device 160 prior to sink device 160 transmitting a feedback packet 300 to a source device. In other examples, the timestamp field may include the timestamp that identifies a different media data packet received at sink device 160. Timestamp values may enable source device 120 to identify which media data packet experienced reported performance degradation and to calculate the roundtrip delay in a WD system.

The length field may comprise a 16-bit field to indicate the length of a feedback packet 300. Based on the value of the length field, source device 120 may identify the end of a feedback packet and the beginning of a new, subsequent feedback packet. The number and sizes of the fields in feedback packet 300 illustrated in FIG. 3 are merely explanatory. In other examples, a feedback packet may include fields having larger or smaller sizes than in feedback packet 300 illustrated in FIG. 3, and/or may include more or fewer fields than feedback packet 300 illustrated in FIG. 3.

Referring back to FIG. 2, in the case of HIDC, generic, and OS specific user input, typically affect how subsequent media data is presented to the user at sink device 160, (e.g., zoom and pan operations) and how source device 120 processes (e.g., encodes and/or transmits) the media data to sink device 160.

Human interface device commands (HIDC) 230, generic user inputs 232 and OS specific user inputs 234 may define how types of user inputs are formatted into information elements. As described above these information elements may be encapsulated using feedback packet 300. For example, human interface device commands 230 and generic user inputs 232 may categorize inputs based on user interface type (e.g., mouse, keyboard, touch, multi-touch, voice, gesture, vendor-specific interface, etc.) and commands (e.g. zoom, pan, etc.) and determine how user inputs should be formatted into information elements.

In one example, human interface device commands 230 may format user input data and generate user input values based on defined user input device specifications such as USB, Bluetooth and Zigbee. Tables 1A, 1B and 1C provide examples of an HIDC input body format, HID Interface Type and HID Type values. In one example, human interface device commands (HIDC) 230 may be defined according to WFD. In Table 1A, the HID Interface Type field specifies a human interface device (HID) type. Examples of HID interface types are provided in Table 1B. The HID Type field specifies a HID type. Table 1C provides examples of HID types. The length field specifies the length of an HIDC value in octets. The HIDC includes input data which may be defined in specifications such as Bluetooth, Zigbee, and USB.

TABLE 1A
HIDC Body Format

| Field | Size (Octet) | Value |
|---|---|---|
| HID Interface Type | 1 | HID Interface Type. See |
| | | Table 1B |
| HID Type | 1 | HID Type. See Table 1C |
| Length | 2 | Length of HIDC value in |
| | | octets |
| HIDC Value | Variable | HIDC input data which is |
| | | defined in other |
| | | specifications such as |
| | | Bluetooth, Zigbee, and |
| | | USB. |

TABLE 1B
HIDC Interface Type

| Value | HID Interface Type |
|---|---|
| 0 | Infrared |
| 1 | USB |
| 2 | Bluetooth |
| 3 | Zigbee |
| 4 | Wi-Fi |
| 5-254 | Reserved |
| 255 | Vendor Specific HID interface |

TABLE 1C
HID Type

| Value | HID Type |
|---|---|
| 0 | Keyboard |
| 1 | Mouse |
| 2 | Single Touch |
| 3 | Multi Touch |
| 4 | Joystick |
| 5 | Camera |
| 6 | Gesture |
| 7 | Remote controller |
| 8-254 | Reserved |
| 255 | Vendor specific HID type |

In one example, generic user inputs 232 may be processed at the application level and formatted as information elements independent of a specific user input device. Generic user inputs 232 may be defined by the WFD standard. Tables 2A and 2B provide examples of a generic input body format and information elements for generic user inputs. In Table 2A, the Generic IE ID field specifies a Generic information element (IE) ID type. Examples of Generic IE ID types are provided in Table 2B. The length field specifies the length of a Generic IE ID value in octets. The describe field specifies details of a user input. It should be noted that for the sake of brevity that the details of the user inputs in the describe field in Table 2A have not been described, but in some examples may include X-Y coordinate values for mouse touch/move events, ASCII key codes and control key codes, zoom, scroll, and rotation values. In one example, human interface device commands (HIDC) 230 and generic user inputs 232 may be defined according to WFD.

TABLE 2A
Generic Input Body Format

| Field | Size (Octet) | Value |
|---|---|---|
| Generic IE ID | 1 | Input type, such as Zoom |
| | | In, Scroll. See Table 2B |
| Length | 2 | Length of the following |
| | | fields in octets |
| Describe | Variable | The details of user inputs |

TABLE 2B
Generic Input Body Format

| Generic IE ID | Notes |
|---|---|
| 0 | Left Mouse Down/Touch Down |
| 1 | Left Mouse Up/Touch Up |
| 2 | Mouse Move/Touch Move |
| 3 | Key Down |
| 4 | Key Up |
| 5 | Zoom |
| 6 | Vertical Scroll |
| 7 | Horizontal Scroll |
| 8 | Rotate |
| 9-255 | Reserved |

OS-specific user inputs 234 are device platform dependent. For different device platforms, such as iOS®, Windows Mobile®, and Android®, the formats of user inputs may be different. The user inputs categorized as interpreted user inputs may be device platform independent. Such user inputs are interpreted in a standardized form to describe common user inputs that may direct a clear operation. A wireless display sink and the wireless display source may have a common vendor specific user input interface that is not specified by any device platform, nor standardized in the interpreted user input category. For such a case, the wireless display source may send user inputs in a format specified by the vendor library. Forwarding user inputs may be used to forward messages not originating from a wireless display sink. It is possible that the wireless display sink may send such messages from a third device as forwarding user input, and can then expect the wireless display source to respond to those messages in the correct context.

Performance analysis 236 may define techniques for determining performance information and may define how media performance data is formatted into information elements. The performance information may include performance indicators of a WD system and the media data communication channel that are capable of being measured or calculated at sink device 160. For example, the performance information feedback may include one or more of round trip delay, delay jitter, packet loss ratio, packet error ratio, error distribution, and received signal strength indication (RSSI). In another example, performance information may include explicit requests such as a request to increase or decreases a bit rate, a request for an instantaneous decoder refresh frame.

In one example, sink device 160 may determine performance information based on media data packets received from source device 120. For example, sink device 160 may calculate delay jitter between consecutive received media data packets, packet loss at either the application level or the Media Access Control (MAC) level, error distribution in time based on packet loss, and RSSI distribution in time.

In another example, sink device 160 may calculate delay jitter of media data packets received from source device 120. The delay jitter comprises the variation in delay times between packets. Delay jitter may be calculated based on inter-packet arrival time, because packets are transmitted on a fixed interval such that differences in arrival time may indicate differences in delay times. However, this calculation may only be accurate when transmitting packets over a network where the roundtrip delay is much larger than the packet transmission time, such that changes to the packet transmission time will not significantly affect the inter-packet arrival time. In should be noted that in some cases, the packet transmission time may vary widely based on the size of the packet being transmitted.

In an example where a WD system transmits media data packets over a single link the packet transmission time may be of the same magnitude as the roundtrip delay such that changes to the packet transmission time will significantly affect the inter-packet arrival time. Therefore, a conventional delay jitter calculation may result in an inaccurate measure of the channel condition over the single link. According to the techniques of this disclosure, sink device 160 may measure the inter-packet arrival time and then calculate a normalized inter-packet arrival time based on the size of the packet received from source device 120. Sink device 160 may then calculate delay jitter based on the normalized inter-packet arrival time. As an example, sink device 160 may use the following formula:

X′=(X−max(T−F,0))/L, where F:=X−max(T−F,0), (1)

In formula (I), X′ denotes the normalized inter-packet arrival time, X denotes the measured inter-packet arrival time, T denotes the packet generation interval, F denotes the packet transmission interval, and L denotes the packet size.

In another example, sink device 160 may calculate packet loss and error distribution in time based on the packet loss and sends the error distribution in time as performance information feedback to a source device 120. In one example, sink device 160 may calculate packet loss in a sequence of media data packets received at sink device 1160. For example, sink device 160 may detect lost packets at either the application level based on RTP sequence numbers associated with the received media data packets, or at the MAC level. Sink device 160 may calculate an explicit error distribution in time based on the detected packet loss at the application level, or an implicit error distribution in time based on the detected packet loss at the MAC level.

As one example, sink device 160 may calculate an explicit error distribution in time based on the RTP sequence numbers of the lost packets detected at the application level. In this case, sink device 160 may inform source device 120 of the explicit error distribution in time by sending the RTP sequence numbers that were not received. However, the explicit error distribution in time may lack granularity, because it fails to take concatenated or broken-up packets into account when detecting the missing RTP sequence numbers. Based on the received RTP sequence numbers in the feedback packet, source device 120 can determine exactly which media data packets were lost.

As another example, sink device 160 may calculate an implicit error distribution in time based on the times at which lost packets were detected at the MAC level. More specifically, an implicit error distribution in time may be represented using the time elapsed from a detected packet loss at the MAC level to the time the feedback packet is generated. Alternatively, an implicit error distribution in time may be represented using the number of lost packets detected at the MAC level during a predetermined time interval. Sink device 160 may inform source device of the implicit error distribution in time by sending the packet loss timing information with a timestamp value to source device 120. The implicit error distribution in time may provide finer granularity of performance information to source device 120. Based on the received packet loss timing information and the timestamp value in the feedback packet, source device 120 may infer which media data packets were lost or experienced some disturbance. Based on the received performance information feedback, source device 120 may determine which media data packets were lost and how important the lost packets were to the overall media sequence. If a lost packet is very important, e.g., it contained a reference or I-frame for a video sequence, source device 120 may decide to retransmit the lost packet. In other cases, source device 120 may adjust its media data encoding quality for subsequent media data packets transmitted to sink device based on the error distribution and the importance of the lost media data packets.

In another example, sink device 120 may calculate a received signal strength indication (RSSI) distribution in time and transmit the RSSI distribution in time as performance information feedback to source device 120. A RSSI measurement indicates how strong the communication signal is when a packet is received. Therefore, the RSSI distribution in time provides an indication of when the signal strength is low and that any packet loss at that time is likely due to low signal strength and not interference. Sink device 160 may calculate a RSSI distribution in time based on the times at which RSSI measurements were taken. More specifically, a RSSI distribution in time may be represented using the time elapsed from a RSSI measurement to the time the feedback packet is generated. In this case, sink device 160 may inform source device 120 of the RSSI distribution in time by sending the elapsed timing information with a timestamp value to source device 120 via the feedback channel. Alternatively, source device 120 may compare a RSSI measurement against a previous RSSI measurement or against a predetermined threshold value. Sink device 160 may then inform source device 120 of the RSSI measurement when it changes from the previous RSSI measurement or exceeds the predetermined threshold value along with a timestamp value. In this case, sink device 160 does not need to send elapsed timing information with the RSSI measurement to source device 120. In either case, source device 120 may receive the RSSI information from sink device 160 via the feedback channel. Based on the received performance information feedback, source device 120 is able to determine the channel condition of the previously transmitted media data packets. When the channel condition is low, source device 120 may infer that any packet loss during the time indicated by the timestamp value and/or the elapsed timing information is likely due to low signal strength and not interference. When the received RSSI measurement is low, therefore, sink device 120 may adjust its media data encoding and encode subsequent media data at a lower quality to avoid further performance degradation.

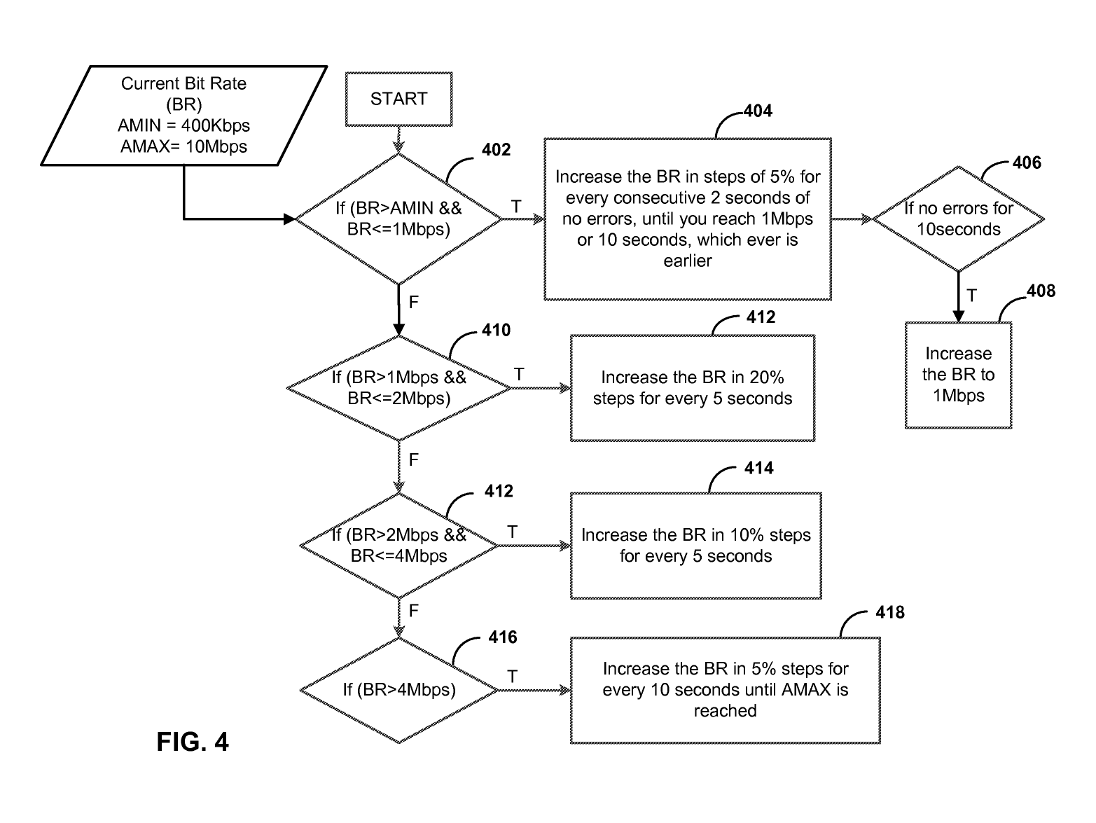

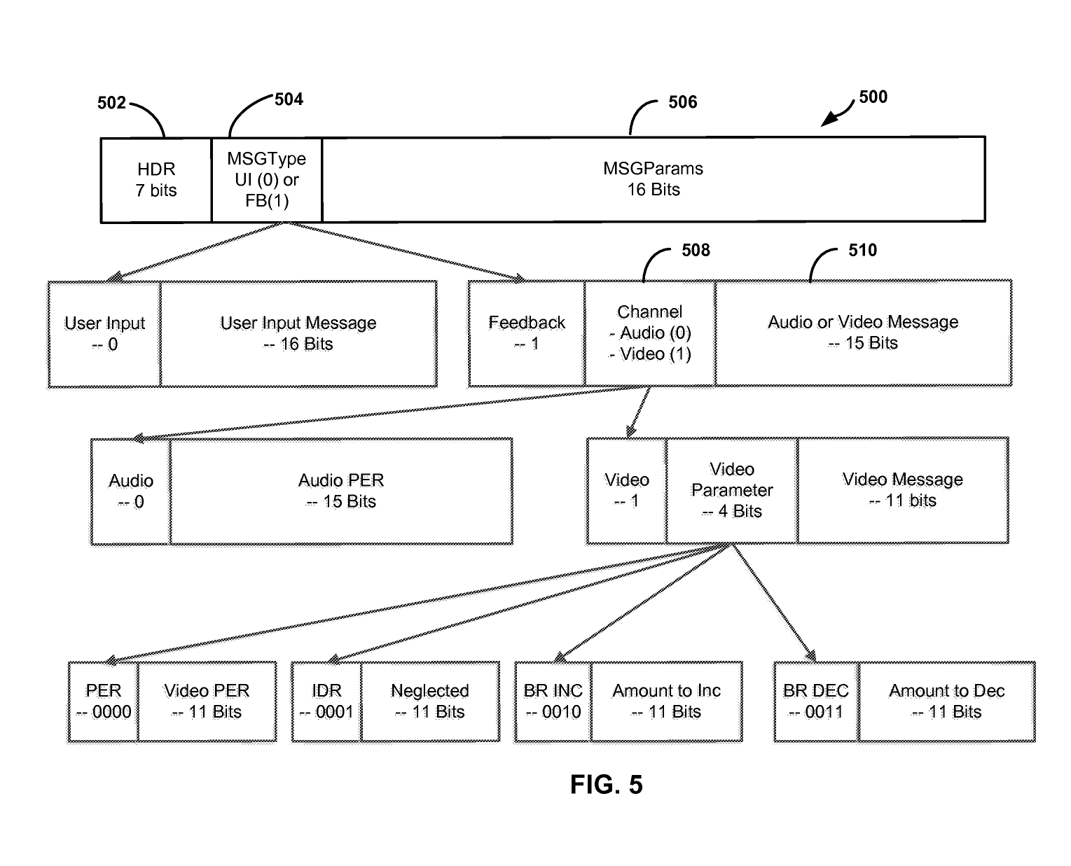

In another example in addition or as an alternative to including measurements as performance information, performance information may include explicit requests such as a request to increase or decreases a bit rate or a request for an instantaneous decoder refresh frame. FIG. 4 is a flowchart illustrating an exemplary operation of adapting the bit rate of media data based on performance information feedback from a sink device to a source device. As described below with respect to FIG. 5, the message format for performance information feedback may indicate whether the feedback information is about the audio channel or the video channel. When the performance feedback information is about the video channel, the message format may further indicate whether the information includes the packet error rate (PER) for the video channel or a request for modifications to the processing of subsequent video data at a source device based on the PER for the video channel. For example, the message format may indicate an encoder parameter requesting to increase the bit rate or decrease the bit rate of the video data. In this case, the feedback information includes the percent of change in the bit rate determined at sink device. The illustrated flowchart provides one example operation of adapting the bit rate at source device 120 based on feedback information from sink device 160.

For purposes of explanation, several variables and constants are defined with specific values. However, the variables and constants may have different values in other examples. In the illustrated example, the variables and constants for the bit rate adaptation are defined as below.

| | | |
|---|---|---|
| Absolute Min Bit Rate: | 400 Kbps | AMIN |
| Starting Bit Rate: | 4 Mbps | SBR |
| Absolute Max Bit Rate: | 10 Mbps | AMAX |
| Waiting Window: | 5 seconds and 10 seconds | WW |
| BR: | Current Bit Rate | BR |

Absolute Min Bit Rate: 400 Kbps AMIN
Starting Bit Rate: 4 Mbps SBR
Absolute Max Bit Rate: 10 Mbps AMAX
Waiting Window: 5 seconds and 10 seconds WW
BR: Current Bit Rate BR

It may be assumed that the increase or decrease of the bit rate happens at the start of the next IDR frame, which is usually within about 1 second. According to the techniques of this disclosure, the PER may be calculated at sink device 160 and an appropriate feedback message to transmit source device 120 may be generated. For example, if the PER >10%, sink device 160 may request an IDR frame in the feedback message. If PER >30%, sink device 160 may request source device 120 to reduce the bit rate along with transmitting an IDR frame, increase the quantization parameter (QP) by 3 or reduce the bit rate by ¼th of the original rate. If PER >70%, sink device 160 may request source device 120 to reduce the bit rate along with transmitting an IDR frame and with the bit rate set to the absolute minimum bit rate (AMIN). If PER=0, sink device 160 may request source device 120 to increase the bit rate for 10 seconds. The bit rate increase or decrease may be a function of the current bit rate and the type of the content being streamed or played over the video channel.

The bit rate adaptation operation described is this disclosure comprises a generalized operation that may be used either in an open loop rate adaptation system (i.e., with no feedback) or in a closed loop rate adaptation system (i.e., with feedback). The same operation may be used to determine the change in bit rate either at source device 120 or sink device 160 by monitoring appropriate parameters. For example, in an open loop system, source device 120 may monitor the transmission rate, statistics on transmitted packets and error packets, and RSSI to determine the appropriate bit rate change based on the parameters. In a closed loop system, according to the techniques of this disclosure, sink device 160 may monitor the parameters and either send the parameters back to source device 120 as performance information feedback for source device 120 to determine the bit rate change, or determine the bit rate change based on the parameters and send a request for a bit rate change back to source device 120 as feedback.

When there are no errors being reported back to source device 120 from sink device 160, source device 120 may increase the bit rate based on the operation illustrated in FIG. 4. Alternatively, the operation illustrated in FIG. 4 may be applied at sink device 160 to determine the amount of bit rate increase, and sink device 160 may then report the rate change back to source device 120 over the feedback channel.

In the example illustrated in FIG. 4, at step 402, if the current bit rate (BR) is greater than the absolute minimum bit rate (AMIN) and less than or equal to a first bit rate threshold, 1 Mbps, at step 404, source device 120 may increase the bit rate in steps of 5% for every 2 seconds of no errors (PER=0) until source device 120 reaches 1 Mbps (megabits per second) or 10 seconds, whichever is earlier. At step 406, if 10 seconds is reached without any errors, then the bit rate is increased directly to 1 Mbps at step 408.

Continuing the example of FIG. 4, at step 410 if the current bit rate (BR) is greater than 1 Mbps and less than or equal to a second bit rate threshold, 2 Mbps, at step 412, source device 120 may increase the bit rate in steps of 20% for every 5 seconds. At step 412, if the current bit rate (BR) is greater than 2 Mbps and less than or equal to, a third bit rate threshold, 4 Mbps, at step 414 source device 120 may increase the bit rate in steps of 10% for every 5 seconds. At step 416, if the current bit rate (BR) is greater than 4 Mbps, at step 418 source device 120 may increase the bit rate in steps of 5% for every 10 seconds until the absolute maximum bit rate (AMAX) is reached.

The value of 1 Mbps used in the example operation illustrated in FIG. 4 corresponds to a nominal quality level for WVGA (Wide Video Graphics Array) at 30 frames per second (fps) video for wireless display operation. The rate change varies between minimum and maximum bit rates corresponding to low and high quality levels depending on the video format. Table 3, below, describes the minimum bit rate, nominal bit rate, and maximum bit rate for various video formats. The values in Table 3 are provided as a guideline only. Other examples may include additional video formats and/or different minimum, nominal and maximum bit rates associated with each of the video formats. The operation illustrated in FIG. 4 may be adapted to other video formats and quality levels through simple extrapolation.

TABLE 3

| Video Format | Min Bit Rate | Nominal Bit Rate | Max Bit Rate |
|---|---|---|---|
| WVGA@30 fps | 400 kbps | 1 Mbps | 4 Mbps |
| 720p@30 fps | 2 Mbps | 6 Mbps | 10 Mbps |
| 1080p@30 fps | 4 Mbps | 10 Mbps | 20 Mbps |

In general, the values provided above for the minimum bit rates, nominal bit rates, maximum bit rates, bit rate increases, and time periods of the bit rate increases are exemplary for the example bit rate adaptation operation illustrated in FIG. 4. In other examples, different values or values approximately equal to the values used herein may be used to perform a bit rate adaptation operation similar to that illustrated in FIG. 4. For example, first bit rate threshold, second bit rate threshold, and third bit rate threshold may be modified upward or downward and each time period corresponding to each threshold may be increased or decreased.

FIG. 3 is a conceptual diagram illustrating an exemplary message format for user input or feedback messages. User input or feedback messages may be included in payload data 304 of feedback packet 300 from FIG. 3 in several different scenarios. The illustrated message format 500 may be used to send messages about either user input or feedback. A feedback message may include information about the impact of channel conditions on audio and/or video data. A two-byte message may be sent using the illustrated message format in FIG. 5 when sink device 160 requests some modifications to the media data at source device 120. For example, sink device 160 may use the message format to send user input to source device 120 to modify how the media data is presented to the user at sink device 160, e.g., zoom and pan operations. According to the techniques of this disclosure, sink device 160 may use the message format to send performance information feedback to source device 120 to modify how source device 120 encodes and/or transmits the media data to sink device 160.

The illustrated message format 500 for the user input or feedback messages includes a header (HDR) field 502, a message type (MSGType) field 504, and a message parameters (MSGParams) field 506. More specifically, HDR field 502 may be a 7-bit field that includes a standard header for the message to identify that the message includes modification information for source device 120. MSGType field 504 may be a 1-bit field that indicates the type of the message being sent. For example, MSGType field 504 with a value of 0 indicates that the message is a user input message. MSGType field 504 with a value of 1 indicates that the message is a feedback message. MSGParams field 506 may be a 16-bit field that includes the parameters of the message.

In the case where MSGType field 504 indicates that the message is a user input message, the message parameters in MSGParams field 506 include the user input message requesting source device 120 to modify how the media data is presented to the user at sink device 160, e.g., zoom and pan operations. In the case where MSGType field 504 indicates that the message is a feedback message, the message parameters in MSGParams field 506 include a channel field 508 and an audio or video message 510 requesting source device 120 to modify how the media data is encoded and transmitted to sink device 160.

Channel field 508 first indicates whether the feedback information is about an audio channel or video channel. The audio or video message field 510 may then specify the packet error rate (PER) for the audio or video channel, respectively. Sink device 160 may calculate the PER for either an audio or video channel in a sync window interval instead of over ever increasing value. The sync window may be defined to be 1 second. Sink device 160, therefore, may compute the PER for every second and generate a feedback message to be sent to source device 120. Alternatively, the audio or video message field 510 may request modifications to the processing of subsequent video data at source device 120 based on the PER for the video channel. For example, sink device 160 may send a feedback message to request an instantaneous decoder refresh (IDR) frame, an increased bit rate, or a decreased bit rate from source device 120 based on the PER for the video channel calculated at sink device 16.

More specifically, channel field 508 may comprise a 1-bit field that indicates whether the feedback information is about the audio channel or the video channel. When channel field 508 has a value of 0 indicating the audio channel, the 15-bit audio or video message 510 may be used to send the PER and the total number of packets for the audio channel. In one example, the audio channel may be in pulse-code modulation (PCM) format.

When channel field 508 has a value of 1 indicating the video channel, the 15-bit audio or video message 510 may include a video parameter field and a video message. Video parameter field may be a 4-bit field that indicates the type of information included in video message. Video message may be an 11-bit field used to send either the PER for the video channel or an encoder parameter on which source device 120 can directly operate. Table 4, below, provides video message types included in video message for the different values of video parameter field.

TABLE 4

Video Parameter

| Bit 1 | Bit 2 | Bit 3 | Bit 4 | Video Message |
|---|---|---|---|---|
| 0 | 0 | 0 | 0 | PER |
| 0 | 0 | 0 | 1 | IDR Frame |
| 0 | 0 | 1 | 0 | Increase Bit Rate |
| 0 | 0 | 1 | 1 | Decrease Bit Rate |

| | |
|---|---|
| All others | Reserved |

When video parameter field indicates an encoder parameter requesting to increase bit rate (BR INC) or decrease bit rate (BR DEC), then the percent of change in the bit rate may be determined and the result may be sent using the remaining 11 bits of video message. In one example, the bit rate adaptation is may utilize the techniques described in more detail with respect to FIG. 4. When video parameter field indicates an encoder parameter requesting an IDR frame, the remaining 11 bits of video message may be neglected or used to send other performance information. In addition, when video parameter field indicates the PER for the video channel, the remaining 11 bits of video message may be used to send the PER information for the video channel back source device 120.

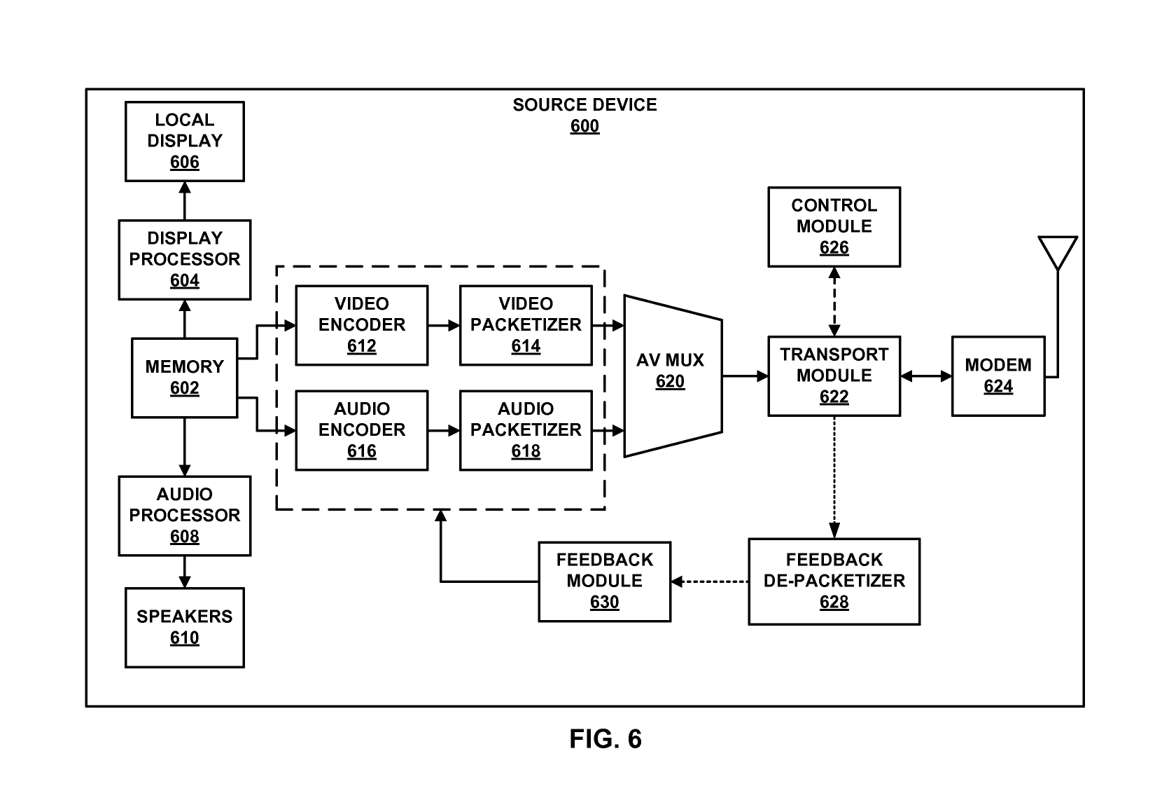

FIG. 6 is a block diagram illustrating an example of a source device that may implement techniques adjusting of transmission of media data based on a performance information message. Source device 600 may be part of a WD system that incorporates the data communication model provided in FIG. 2. Source device 600 may be configured to encode and/or decode media data for transport, storage, and/or display. Source device 600 includes memory 602, display processor 604, local display 606, audio processor 608, speakers 610, video encoder 612, video packetizer 614, audio encoder 616, audio packetizer 618, AN mux 620, transport module 622, modem 624, control module 626, feedback de-packetizer 628, and feedback module 630. The components of source device 600 may be implemented as any of a variety of suitable circuitry, such as one or more microprocessors, digital signal processors (DSPs), application specific integrated circuits (ASICs), field programmable gate arrays (FPGAs), discrete logic, software, hardware, firmware or any combinations thereof.

Memory 602 may store AN visual data in the form of media data in compressed or uncompressed formats. Memory 602 may store an entire media data file, or may comprise a smaller buffer that simply stores a portion of a media data file, e.g., streamed from another device or source. Memory 602 may comprise any of a wide variety of volatile or non-volatile memory, including but not limited to random access memory (RAM) such as synchronous dynamic random access memory (SDRAM), read-only memory (ROM), non-volatile random access memory (NVRAM), electrically erasable programmable read-only memory (EEPROM), FLASH memory, and the like. Memory 602 may comprise a computer-readable storage medium for storing media data, as well as other kinds of data. Memory 602 may additionally store instructions and program code that are executed by a processor as part of performing the various techniques described in this disclosure.

Display processor 604 may obtain captured video frames and may process video data for display on local display 606. Display 606 comprise one of a variety of display devices such as a liquid crystal display (LCD), a plasma display, an organic light emitting diode (OLED) display, or another type of display device capable of presenting video data to a user of source device 600.

Audio processor 608 may obtain audio captured audio samples and may process audio data for output to speakers 610. Speakers 610 may comprise any of a variety of audio output devices such as headphones, a single-speaker system, a multi-speaker system, or a surround sound system.

Video encoder 612 may obtain video data from memory 602 and encode video data to a desired video format. Video encoder 612 may be a combination of hardware and software used to implement aspects of video codec 218 described above with respect to FIG. 2. Video encoder 612 may encode the video according to any number of video compression standards, such as ITU-T H.261, ISO/IEC MPEG-1 Visual, ITU-T H.262 or ISO/IEC MPEG-2 Visual, ITU-T H.263, ISO/IEC MPEG-4 Visual, ITU-T H.264 (also known as ISO/IEC MPEG-4 AVC), VP8 and High-Efficiency Video Coding (HEVC). It should be noted that in some cases video encoder 612 may encode video such that video data is compressed using a lossless or lossy compression technique.

Video packetizer 614 may packetize encoded video data. In one example video packetizer 614 may packetize encoded video data as defined according to MPEG-2 Part 1. In other examples, video data may be packetized according to other packetization protocols. Video packetizer 614 may be a combination of hardware and software used to implement aspects of packetized elementary stream (PES) packetization 216 described above with respect to FIG. 2.

Audio encoder 616 may obtain audio data from memory 602 and encode audio data to a desired audio format. Audio encoder 616 may be a combination of hardware and software used to implement aspects of audio codec 220 described above with respect to FIG. 2. Audio data may be coded using multi-channel formats such those developed by Dolby and Digital Theater Systems. Audio data may be coded using a compressed or uncompressed format. Examples of compressed audio formats include MPEG-1, 2 Audio Layers II and III, AC-3, AAC. An example of an uncompressed audio format includes pulse-code modulation (PCM) audio format.

Audio packetizer 618 may packetize encoded audio data. In one example, audio packetizer 618 may packetize encoded audio data as defined according to MPEG-2 Part 1. In other examples, audio data may be packetized according to other packetization protocols. Audio packetizer 618 may be a combination of hardware and software used to implement aspects of packetized elementary stream (PES) packetization 216 described above with respect to FIG. 2.

A/V mux 620 may apply multiplexing techniques to combine video payload data and audio payload data as part of a common data stream. In one example, A/V mux 620 may encapsulate packetized elementary video and audio streams as an MPEG2 transport stream defined according to MPEG-2 Part 1. A/V mux 620 may provide synchronization for audio and video packets, as well as error correction techniques.

Transport module 622 may process media data for transport to a sink device. Further, transport module 622 may process received packets from a sink device so that they may be further processed. For example, transport module 622 may be configured to communicate using IP, TCP, UDP, RTP, and RSTP. For example, transport module 622 may further encapsulate an MPEG2-TS for communication to a sink device or across a network.

Modem 624 may be configured to perform physical and MAC layer processing according to the physical and MAC layers utilized in a WD system. As described with reference to FIG. 2. Physical and MAC layers may define physical signaling, addressing and channel access control used for communications in a WD system. In one example, modem 624 may configured to perform physical layer and MAC layer processing for physical and MAC layers defined by a Wi-Fi (e.g., IEEE 802.11x) standard, such as that provided by WFD. In other examples, modem 624 may configured to perform physical layer and MAC layer processing for any of: WirelessHD, WiMedia, Wireless Home Digital Interface (WHDI), WiGig, and Wireless USB.

Control module 626 may be configured to perform source device 600 communication control functions. Communication control functions may relate to negotiating capabilities with a sink device, establishing a session with a sink device, and session maintenance and management. Control module 626 may use RTSP to communication with a sink device. Further, control module 626 may establish a feedback channel using an RTSP message transaction to negotiate a capability of source device 600 and a sink device to support the feedback channel and feedback input category on the UIBC. The use of RTSP negotiation to establish a feedback channel may be similar to using the RTSP negotiation process to establish a media share session and/or the UIBC.

Feedback de-packetizer 628 may parse human interface device commands (HIDC), generic user inputs, OS specific user inputs, and performance information from a feedback packet. In one example, a feedback packet may use the message format described with respect to FIG. 3. In this example, feedback de-packetizer 628 may determine how to parse a feedback packet based in part on the value of a feedback category field in a feedback packet header. As one example, a feedback category field may identify a generic input category to indicate that feedback packet payload data is formatted using generic information elements. As another example, the feedback category field may identify a human interface device command (HIDC) input category. As another example, the feedback category field may identify an operating system (OS) specific input category to indicate that payload data is formatted based on the type OS used by either the source device or the sink device.

In another example, feedback de-packetizer 628 may determine how to parse a feedback packet based in part on payload data of feedback packet. In one example, a feedback packet may be use the message format described with respect to FIG. 3 and the feedback message payload may be formatted according to the example in FIG. 5.

Feedback module 630 receives performance information from feedback de-packtetizer and processes performance information such that source device 600 may adjust the transmission of media data based on a performance information message. As described above, the transmission of media data may be adjusted by any combination of the following techniques: an encoding quantization parameter may be adjusted, the quality of media data may be adjusted, the length of media packets may be adjusted, an instantaneous decoder refresh frame may be transmitted, encoding or transmission bit rates may be adjusted, and redundant information may be transmitted based on a probability of media data packet loss.

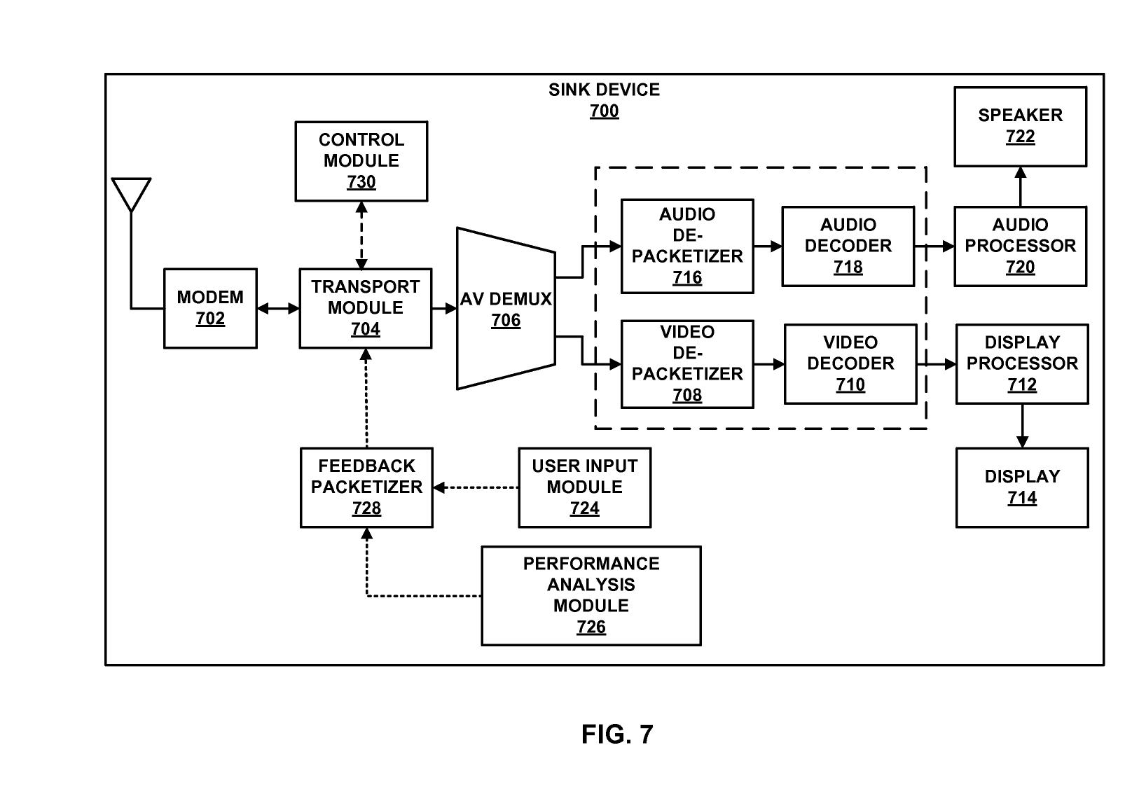

FIG. 7 is a block diagram illustrating an example of a sink device that implements techniques for sending performance information feedback to a source device to adjust media data, e.g., audio video (AV) data, processing at a source device. Sink device 700 may be part of a WD system that incorporates the data communication model provided in FIG. 2. In one example, Sink device 700 may form a WD system with source device 600. Sink Device 700 includes modem 702, transport module 704, AN demux 706, video de-packetizer 708, video decoder 710, display processor 712, display 714, audio depacketizer 716, audio decoder 718, audio processor 720, speaker 722, user input module 724, performance analysis module 726, feedback packetizer 728, and control module 730. The components of sink device 700 each may be implemented as any of a variety of suitable circuitry, such as one or more microprocessors, digital signal processors (DSPs), application specific integrated circuits (ASICs), field programmable gate arrays (FPGAs), discrete logic, software, hardware, firmware or any combinations thereof.

Modem 702, may be configured to perform physical and MAC layer processing according to the physical and MAC layers utilized in a WD system. As described with reference to FIG. 2. Physical and MAC layers may define physical signaling, addressing and channel access control used for communications in a WD system. In one example, modem 702 may configured to perform physical layer and MAC layer processing for physical and MAC layers defined by a Wi-Fi (e.g., IEEE 802.11x) standard, such as that provided by WFD. In other examples, modem 702 may configured to perform physical layer and MAC layer processing for any of: WirelessHD, WiMedia, Wireless Home Digital Interface (WHDI), WiGig, and Wireless USB.

Transport module 704, may process received media data from a source device. Further, transport module 704 may process feedback packets for transport to a source device. For example, transport module 704 may be configured to communicate using IP, TCP, UDP, RTP, and RSTP. In addition, transport module 704 may include a timestamp value in any combination of IP, TCP, UDP, RTP, and RSTP packets. The timestamp values may enable a source device to identify which media data packet experienced a reported performance degradation and to calculate the roundtrip delay in a WD system.

A/V demux 706, may apply de-multiplexing techniques to separate video payload data and audio payload data from data stream. In one example, A/V mux 706 may separate packetized elementary video and audio streams of an MPEG2 transport stream defined according to MPEG-2 Part 1.

Video de-packetizer 708 and Video decoder 710 may perform reciprocal processing of a video packetizer and a video encoder implementing packetization and coding techniques described herein and output video output video data to display processor 712.

Display processor 712 may obtain captured video frames and may process video data for display on display 714. Display 714 may comprise one of a variety of display devices such as a liquid crystal display (LCD), a plasma display, an organic light emitting diode (OLED) display, or another type of display.

Audio de-packetizer 716 and audio decoder 718 may perform reciprocal processing of an audio packetizer and audio encoder implementing packetization and coding techniques described herein and output audio data to display processor 720

Audio processor 720 may obtain audio data from audio decoder and may process audio data for output to speakers 722. Speakers 722 may comprise any of a variety of audio output devices such as headphones, a single-speaker system, a multi-speaker system, or a surround sound system.

User input module 724 may format user input commands received by user input device such as, for example, a keyboard, mouse, trackball or track pad, touch screen, voice command recognition module, or any other such user input device. In one example user input module 724 may format user input commands according formats defined according to Human interface device commands (HIDC) 230, generic user inputs 232 and OS specific user inputs 234 described above with respect to FIG. 2.

Performance analysis module 726 may determine performance information based on media data packets received from a source device. Performance information may include: delay jitter, packet loss, error distribution in time, packet error ratio, and RSSI distribution in time, as well as other examples described herein. Performance analysis module 726 may calculate performance information according to any of the techniques described herein.

Feedback packetizer 728 may packet may process the user input information from user input module 724 and performance analysis module generator 726 to create feedback packets. In one example, a feedback packet may use the message format described with respect to FIG. 3. In addition, feedback packetizer 728 may include a timestamp value in each of the feedback packets. The timestamp values may enable a source device to identify which media data packet experienced reported performance degradation and to calculate the roundtrip delay in a WD system.

Control module 730 may be configured to perform sink device 700 communication control functions. Communication control functions may relate to negotiating capabilities with a source device, establishing a session with a source device, and session maintenance and management. Control module 730 may use RTSP to communication with a source device. Further, control module 730 may establish a feedback channel using an RTSP message transaction to negotiate a capability of sink device 700 and a source device to support the feedback channel and feedback input category on the UIBC. The use of RTSP negotiation to establish a feedback channel may be similar to using the RTSP negotiation process to establish a media share session and/or the UIBC.

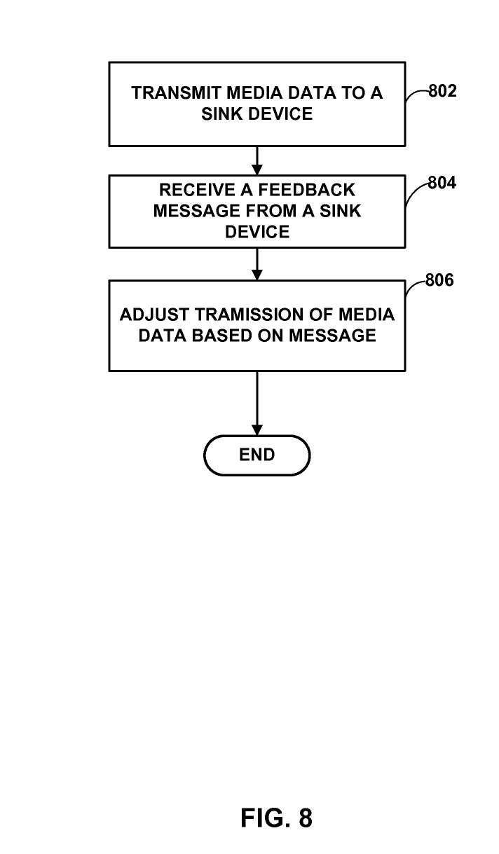

FIG. 8 is a flowchart illustrating a technique for adjusting the transmission of media data based on feedback information. A source device transmits media data a sink device. Source device and sink device may be any combination of source and sink devices described herein (802). In one example, media data may be transmitted according to UDP. A source device receives a feedback message from a sink device (804). A feedback message may be formatted according any message format described herein and include any type of feedback information described herein. For example, feedback message may be formatted according to message format described with respect to FIG. 3. In one example, a received feedback message may be transmitted according to TCP. A source device may adjust the transmission of media data based on the feedback message according to any of the techniques described herein (806). For example, the transmission of media data may be adjusted by any combination of the following techniques: an encoding quantization parameter may be adjusted, the length of media packets may be adjusted, an instantaneous decoder refresh frame may be transmitted, encoding or transmission bit rates may be adjusted, and redundant information may be transmitted based on a probability of media data packet loss.

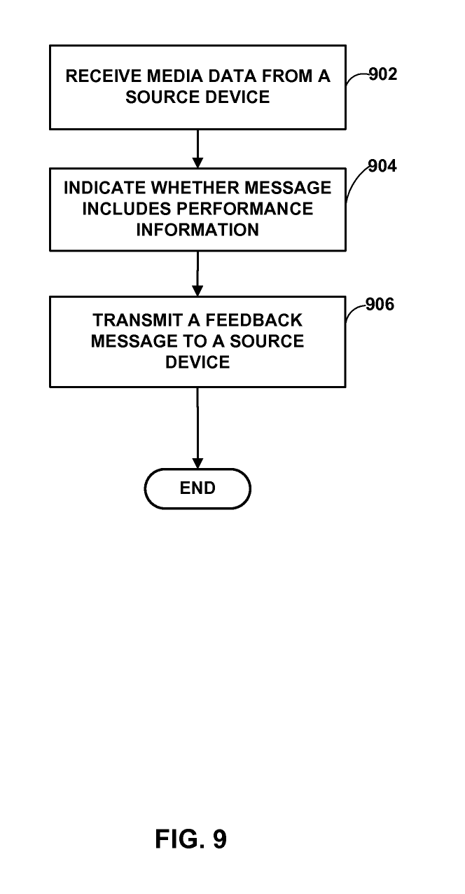

FIG. 9 is a flowchart illustrating a technique for providing feedback information. A sink device receives media data from a source device (902). Source device and sink device may be any combination of source and sink devices described herein. In one example, media data may be transmitted according to UDP. A sink device indicates whether a message to be transmitted to a source includes performance information (904). In one example, sink device may indicate a message includes performance information using a data packet header value. For example, a sink device may specify the contents of a message using feedback category field in FIG. 3 and/or the MSGType field in FIG. 5. A sink device transmits a feedback message to a source device (906). A feedback message may be formatted according any message format described herein and include any type of feedback information described herein. In one example, a feedback message may be transmitted according to TCP.

In one or more examples, the functions described may be implemented in hardware, software, firmware, or any combination thereof. If implemented in software, the functions may be stored on or transmitted over as one or more instructions or code on a computer-readable medium. Computer-readable media may include computer data storage media or communication media including any medium that facilitates transfer of a computer program from one place to another. In some examples, computer-readable media may comprise non-transitory computer-readable media. Data storage media may be any available media that can be accessed by one or more computers or one or more processors to retrieve instructions, code and/or data structures for implementation of the techniques described in this disclosure.

By way of example, and not limitation, such computer-readable media can comprise non-transitory media such as RAM, ROM, EEPROM, CD-ROM or other optical disk storage, magnetic disk storage, or other magnetic storage devices, flash memory, or any other medium that can be used to carry or store desired program code in the form of instructions or data structures and that can be accessed by a computer. Also, any connection is properly termed a computer-readable medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The code may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various embodiments of the invention have been described. These and other embodiments are within the scope of the following claims.

What is claimed is:

1. A method of transmitting media data, the method comprising:
transmitting media data to a sink device, wherein media data is transported according to a first transport protocol;
receiving a message from the sink device, wherein the message is transported according to a second transport protocol;
determining based on at least in part on a data packet header whether the message includes one of: user input information or performance information; and
adjusting the transmission of media data based on the message.

2. The method of claim 1, wherein the first transport protocol is a User Data Protocol (UDP) and the second transport protocol is a Transmission Control Protocol (TCP).

3. The method of claim 1, further comprising determining the capabilities of the sink device using a Real Time Streaming Protocol (RTSP).

4. The method of claim 1, wherein the message includes performance information, wherein the performance information includes at least a timestamp value for the media data received at the sink device.

5. The method of claim 1, wherein the message includes performance information, wherein the performance information includes packet error information and wherein adjusting the transmission of media data based on the message includes adjusting a quantization parameter used to encode the media data.

6. The method of claim 1, wherein the message includes performance information, wherein the performance information includes packet error information and wherein adjusting the transmission of media data based on the message includes transmitting an instantaneous decoder refresh frame.

7. A method of receiving media data, the method comprising:
receiving media data from a source device, wherein media data is transported according to a first transport protocol;
indicating based on at least in part on a data packet header whether a message includes one of: user input information or performance information; and
transmitting the message to the source device, wherein the message is transported according to a second transport protocol.

8. The method of claim 7, wherein the first transport protocol is a User Data Protocol (UDP) and the second transport protocol is a Transmission Control Protocol (TCP).

9. The method of claim 7, further comprising transmitting a capability message using a Real Time Streaming Protocol (RTSP).

10. The method of claim 7, wherein the message includes performance information, wherein the performance information includes at least a timestamp value for the media data received at the sink device.

11. The method of claim 7, wherein the message includes performance information, wherein the performance information includes a request for the source device to adjust the transmission rate of the media data.

12. The method of claim 7, wherein the message includes performance information, wherein the performance information includes a request for the source device to transmit an instantaneous decoder refresh frame.

13. A source device comprising:
means for transmitting media data to a sink device, wherein media data is transported according to a first transport protocol;
means for receiving a message from the sink device, wherein the message is transported according to a second transport protocol;
means for determining based on at least in part on a data packet header whether the message includes one of: user input information or performance information; and
means for adjusting the transmission of media data based on the message.

14. The source device of claim 13, wherein the first transport protocol is a User Data Protocol (UDP) and the second transport protocol is a Transmission Control Protocol (TCP).

15. The source device of claim 13, further comprising means for determining the capabilities of the sink device using a Real Time Streaming Protocol (RTSP).

16. The source device of claim 13, wherein the message includes performance information, wherein the performance information includes at least a timestamp value for the media data received at the sink device.

17. The source device of claim 13, wherein the message includes performance information, wherein the performance information includes packet error information and wherein means for adjusting the transmission of media data based on the message includes means for adjusting a quantization parameter used to encode the media data.

18. The source device of claim 13, wherein the message includes performance information, wherein the performance information includes packet error information and wherein means for adjusting the transmission of media data based on the message includes means for transmitting an instantaneous decoder refresh frame.

19. A sink device comprising:
means for receiving media data from a source device, wherein media data is transported according to a first transport protocol;
means for indicating based at least in part on a data packet header whether a message includes one of: user input information or performance information; and
means for transmitting the message to the source device, wherein the message is transported according to a second transport protocol.

20. The sink device of claim 19, wherein the first transport protocol is a User Data Protocol (UDP) and the second transport protocol is a Transmission Control Protocol (TCP).

21. The sink device of claim 19, further comprising means for transmitting a capability message using a Real Time Streaming Protocol (RTSP).

22. The sink device of claim 19, wherein the message includes performance information, wherein the performance information includes at least a timestamp value for the media data received at the sink device.

23. The sink device of claim 19, wherein the message includes performance information, wherein the performance information includes a request for the source device to adjust the transmission rate of the media data.

24. The sink device of claim 19, wherein the message includes performance information, wherein the performance information includes a request for the source device to transmit an instantaneous decoder refresh frame.

25. A source device comprising:
a memory that stores media data; and
a processor configured to execute instructs to cause the source device to transmit media data to a sink device, wherein media data is transported according to a first transport protocol, process a message received from the sink device, wherein the message is transported according to a second transport protocol, determine based at least in part on a data packet header whether the message includes one of: user input information or performance information, and adjust the transmission of media data based on the message.

26. The source device of claim 25, wherein the first transport protocol is a User Data Protocol (UDP) and the second transport protocol is a Transmission Control Protocol (TCP).

27. The source device of claim 25, wherein the processor is further configured to determine the capabilities of the sink device using a Real Time Streaming Protocol (RTSP).

28. The source device of claim 25, wherein the message includes performance information, wherein the performance information includes at least a timestamp value for the media data received at the sink device.

29. The source device of claim 25, wherein the message includes performance information, wherein the performance information includes packet error information and wherein configured to adjust the transmission of media data based on the message includes adjusting a quantization parameter used to encode the media data.

30. The source device of claim 25, wherein the message includes performance information, wherein the performance information includes packet error information and wherein configured to adjust the transmission of media data based on the message includes transmitting an instantaneous decoder refresh frame.

31. A sink device comprising:
a memory that stores media data; and
a processor configured to execute instructs to cause the sink device to transmit to process media data received from a source device, wherein media data is transported according to a first transport protocol, transmit a message to the source device, wherein the message is transported according to a second transport protocol, and indicate based at least in part on a data packet header whether the message includes one of: user input information or performance information.

32. The sink device of claim 31, wherein the first transport protocol is a User Data Protocol (UDP) and the second transport protocol is a Transmission Control Protocol (TCP).

33. The sink device of claim 31, wherein the processor is further configured to determine the capabilities of the sink device using a Real Time Streaming Protocol (RTSP).

34. The sink device of claim 31, wherein the message includes performance information, wherein the performance information includes at least a timestamp value for the media data received at the sink device.

35. The sink device of claim 31, wherein the message includes performance information, wherein the performance information includes a request for the source device to adjust the transmission rate of the media data.

36. The sink device of claim 31, wherein the message includes performance information, wherein the performance information includes a request for the source device to transmit an instantaneous decoder refresh frame.

37. A computer-readable medium comprising instructions stored thereon that when executed in a processor of a source device cause a the source device to:
transmit media data to a sink device, wherein media data is transported according to a first transport protocol;
process a message received from the sink device, wherein the message is transported according to a second transport protocol;
determine based on at least in part on a data packet header whether the message includes one of: user input information or performance information; and
adjust the transmission of media data based on the message.

38. The computer-readable medium of claim 37, wherein the first transport protocol is a User Data Protocol (UDP) and the second transport protocol is a Transmission Control Protocol (TCP).

39. The computer-readable medium of claim 37, further comprising instructions stored thereon that when executed in a source device cause a programmable processor to determine the capabilities of the sink device using a Real Time Streaming Protocol (RTSP).

40. The computer-readable medium of claim 37, wherein the message includes performance information, wherein the performance information includes at least a timestamp value for the media data received at the sink device.

41. The computer-readable medium of claim 37, wherein the message includes performance information, wherein the performance information includes packet error information and wherein to adjust the transmission of media data based on the message includes adjusting a quantization parameter used to encode the media data.

42. The computer-readable medium of claim 37, wherein the message includes performance information, wherein the performance information includes packet error information and wherein to adjust the transmission of media data based on the message includes transmitting an instantaneous decoder refresh frame.

43. A computer-readable medium comprising instructions stored thereon that when executed in a processor of a sink device cause the sink device to:
process media data received from a source device, wherein media data is transported according to a first transport protocol;
indicate based at least in part on a data packet header whether a message includes one of: user input information or performance information; and
transmit the message to the source device, wherein the message is transported according to a second transport protocol.

44. The computer-readable medium of claim 43, wherein the first transport protocol is a User Data Protocol (UDP) and the second transport protocol is a Transmission Control Protocol (TCP).

45. The computer-readable medium of claim 43, further comprising instructions stored thereon that when executed in a sink device cause a programmable processor to transmit a capability message using a Real Time Streaming Protocol (RTSP).

46. The computer-readable medium of claim 43, wherein the message includes performance information, wherein the performance information includes at least a timestamp value for the media data received at the sink device.

47. The computer-readable medium of claim 43, wherein the message includes performance information, wherein the performance information includes a request for the source device to adjust the transmission rate of the media data.

48. The sink device of claim 43, wherein the message includes performance information, wherein the performance information includes a request for the source device to transmit an instantaneous decoder refresh frame.
